(19) United States
(12) Patent Application Publication
(10) Pub. No.: US 2010/0320337 A1
(43) Pub. Date: Dec. 23, 2010

(54) Gift support structure

(76) Inventors: Gregory G. Bennett, Lake Park, GA (US); Audrey A. Bennett, Lake Park, GA (US)

Correspondence Address: LANGDALE & VALLOTTON, LLP, 1007 N. PATTERSON STREET, VALDOSTA, GA, 31601, US

(21) Appl. No.: 12/456,523

(22) Filed: Jun. 18, 2009

(51) Int. Cl. F16M 11/02; A44B 21/00

(52) U.S. Cl. 248/121; 24/530

(57) ABSTRACT

A structure having a base for supporting vertical struts to display in a generally linear manner Christmas stockings containing gifts thus making each stocking readily identifiable to the gift recipients with improved stability for the structure. This stability is enhanced by angularly offsetting adjoining pairs of the struts relative to each other and with respect to the sides of the base.

### CROSS-REFERENCES TO RELATED APPLICATIONS

None

### FEDERALLY SPONSORED RESEARCH OR DEVELOPMENT

None

### NAMES OF PARTNERS TO A JOINT RESEARCH AGREEMENT

None

### REFERENCE TO “SEQUENCE LISTING”

None

### BACKGROUND OF THE INVENTION

This invention is directed to structures for supporting gifts for festive occasions and, more particularly, to a structure for supporting Christmas stockings and associated Christmas decorations on struts that are angularly separated from each other to improve structural stability, and the like.

The delightful practice in which “ . . . stockings were hung by the chimney with care, in hopes that St. Nicolas soon would be there . . . ” is, with the aid of the high-rise apartment dwelling and modern architecture, swiftly passing from the holiday scene. The typical household no longer has a fireplace, an exposed chimney, and a mantel from which Christmas stockings can be hung. Nevertheless, gaily decorated Christmas stockings stuffed with toys, candies and small presents remain an integral part of the Christmas celebration.

In the absence of the fireplace mantel, however, there remains an unsatisfied need to display these stockings in an adequate manner. For example, one proposal suggests the use of a central, vertically mounted connector rod that supports an array of radially protruding arms each of which supports a respective Christmas stocking. This structure makes it necessary for a Christmas gift recipient to search through the array of hanging stockings in order to find a particular stocking.

Unfortunately, the foregoing structure has several flaws. First, in all but the most unusual circumstances the total weights of the gifts in each of the stockings will differ from one another. This causes an imbalance tending to tip the entire display over onto one side. Second, even with generally balanced stocking weights the actions of two or more gift recipients, eager to find their respective stockings, are quite likely to cause the display to fall to one side with possible damage to some of the gifts and, perhaps, to the display structure. For example, by tilting the loaded display structure just slightly to one side, all of the filled stocking will sway toward that same side thereby aggravating and accelerating the heeling action, when once initiated.

Consequently, there is a need for a more stable apparatus that better displays Christmas stockings and the like.

### BRIEF SUMMARY OF THE INVENTION

These and other disadvantages of earlier proposals for dispensing a gifts on festive and other occasions, of which Christmas gifts are typical, are overcome to a great extent through the practice of the invention. For example, by mounting several protruding struts, each for supporting a respective stocking, in a manner that is generally perpendicular to a base the need generally to balance the individual stocking contents' weight is avoided. The stockings, moreover, so mounted each on an individual strut in a generally linear array not only makes each stocking immediately apparent to its recipient, but it also reduces the likelihood for the structure from being destructively tipped over in that the gift recipients do not need to search and probe around and through the structure for their respective stockings. A further advantage of this novel structure is in its adaptability to family size. By varying the length of the base, the number of protruding struts can be increased or decreased to match the number of anticipated gifts and gift recipients.

A salient feature of the invention also is the angular offset or staggering between adjacent struts relative to the sides of the base. So staggered, the struts further inhibit the entire structure from tipping onto a side. Thus, as a full stocking is swayed to one side the other stockings in the array remain unmoved and do not add their respective weights further to unbalance the structure. Even in response to a relatively violent impact any sway that might be imparted to stockings on struts spaced from the point of impact will be of reduced amplitudes thereby making lesser contributions to tipping the structure over on one side.

Further, the base and the protruding struts also offer support for decorative material evocative of the holiday or other festive event.

These and other features of the invention are described in more complete detail in connection with the following description of preferred embodiments of the invention when taken in conjunction with the figures of the drawing. The scope of the invention, however, is limited only through the claims appended hereto.

### BRIEF DESCRIPTION OF THE SEVERAL VIEWS OF THE DRAWING

FIG. 1 is a perspective view of a typical embodiment of the invention;

FIG. 2 is a perspective view in full section of the embodiment of the invention shown in FIG. 1 from which decorative materials have been removed and looking in the direction of the arrows 2-2 in FIG. 4;

FIG. 3 is a detail front elevation of a typical strut for use in connection with the embodiment of the invention shown in FIGS. 1 and 2;

FIG. 4 is a perspective view of the embodiment of the invention shown in FIG. 1 and from which the Christmas stockings have been removed;

FIG. 5 is a perspective view of the base for an embodiment of the invention for four Christmas stockings and from which decorative materials have been removed;

FIG. 6 is a perspective view of the base for an embodiment of the invention for five Christmas stockings and from which decorative materials have been removed; and

FIG. 7 is a perspective view of the base for an embodiment of the invention for six Christmas stockings and from which decorative materials have been removed.

### DETAILED DESCRIPTION OF THE PREFERRED EMBODIMENT OF THE INVENTION

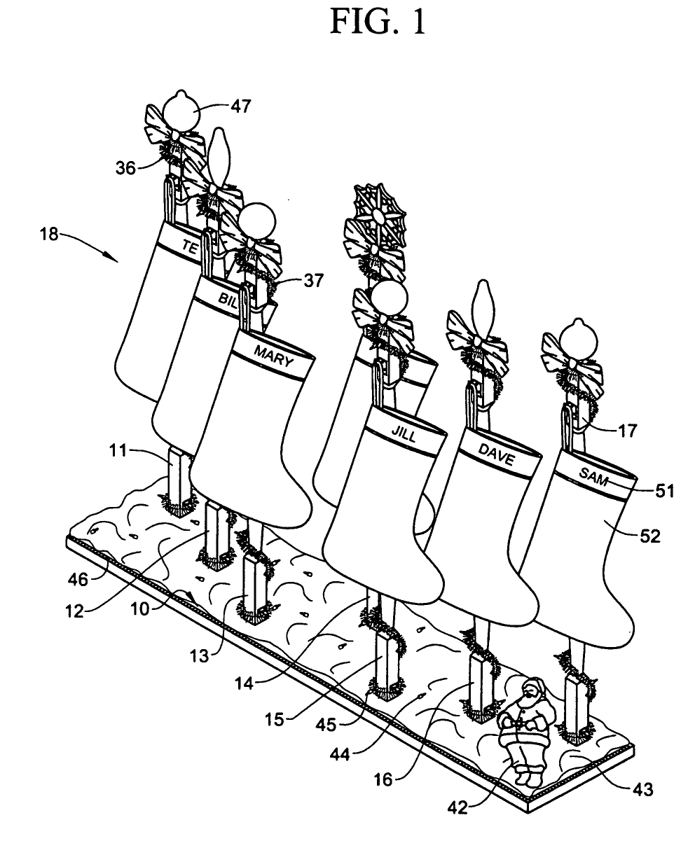

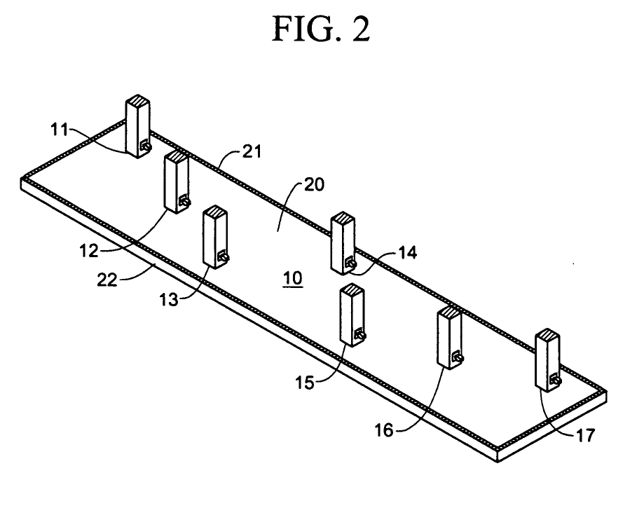

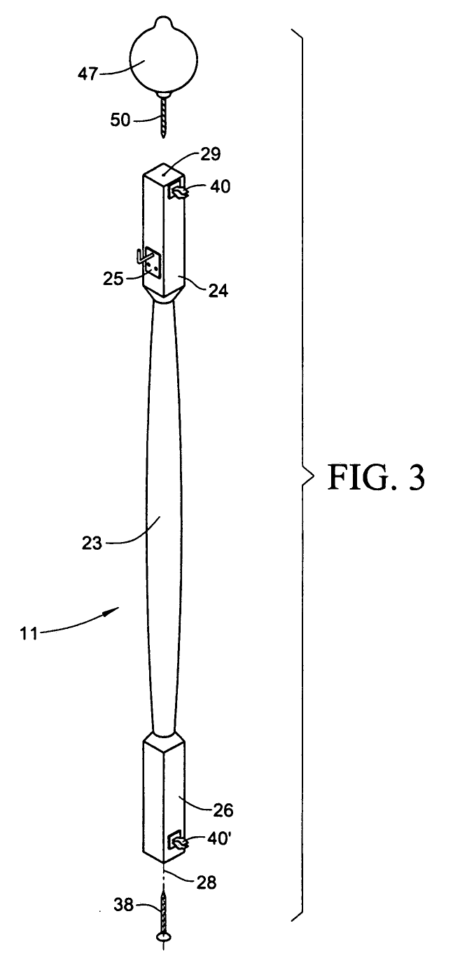

Attention is invited to FIG. 2 which shows a platform or a base 10, illustratively of wood suitable for supporting and displaying seven Christmas stockings (FIG. 1). The base 10 is approximately 50¾ inches in length, 11½ inches in width and 1 inch thick. The base 10 also supports an array of seven protruding struts 11, 12, 13, 14, 15, 16 and 17 only lower portions of which are shown in FIG. 2. The struts 11 through 17 are fastened to flat surface 20 of the base 10 by means of countersunk 2½ inch wood screws (of which screw 38 is shown in FIG. 3) that protrude through the flat surface 20 of the base 10 and into the adjoining ends of the respective struts 11 through 17 in order to secure the struts 11 through 17 to the base 10 in a manner generally perpendicular to the plane of the flat surface 20. To accommodate these wood screws, pre-drilled 7/64 inch pilot holes (not shown) are formed in the base 10.

The positions of the struts 11 through 17, in the illustrative embodiment of this detail of the invention shown in FIG. 2, that bear against the flat surface 20 are square, having sides that are between 1¼ inches to 2 inches in length. The adjoining struts in the arrays of struts 11 through 17 are spaced from and angularly offset relative to each other. For example, the strut 12 is spaced diagonally from the strut 11, the angular offset of the diagonal relative to side 21 of the base 10 being about +15°. Continuing along the base 10 from left to right as viewed in FIG. 2 there are the following angular relationships between consecutive pairs of struts:

| Strut Pairs | Angle | |
|---|---|---|
| 12-13 | +15° | |
| 13-14 | −46° | (measured from side 22) |
| 14-15 | +46° | |
| 15-16 | −15° | (measured from side 22) |
| 16-17 | −15° | (measured from side 22) |

The separations between the foregoing adjoining pairs of struts each being about 6 inches as measured parallel with the sides 21 and 22.

As best shown in FIG. 3, the struts 11 through 17, of which the strut 11 is typical, each are formed from three foot long wooden sticks with square cross-sections preferably of 1¼ inch on each side. Central portion 23 (of 14 inches in length) is turned on a lathe or the like to a generally cylindrical configuration. A first portion 24 of the strut 11 retains its square transverse cross-section and has a length of 11 inches. Note in particular that a metal hanger 25 is attached by wood screws, an appropriate glue or other suitable means to one side of the first portion 24 and close to an end of the strut 11. A 2 inch hole 29 that is 3/32 of an inch in diameter is formed in the center of the strut 11 in general alignment with longitudinal axis 28 of the strut 11. A second portion 26 of the strut 11 at the end of the strut 11 that is opposite to the first portion 24 also retains its square cross section. It is, moreover, this second portion that is fastened to the base 10 (FIG. 2) through the countersunk wood screw 38 mentioned above. The placement of the wood screw 38 within the second portion 26 is secured through a 7/64 inch pilot hole (not shown in the Drawing) that is formed coincident with the longitudinal axis 28 of the strut 11 in the second portion 26.

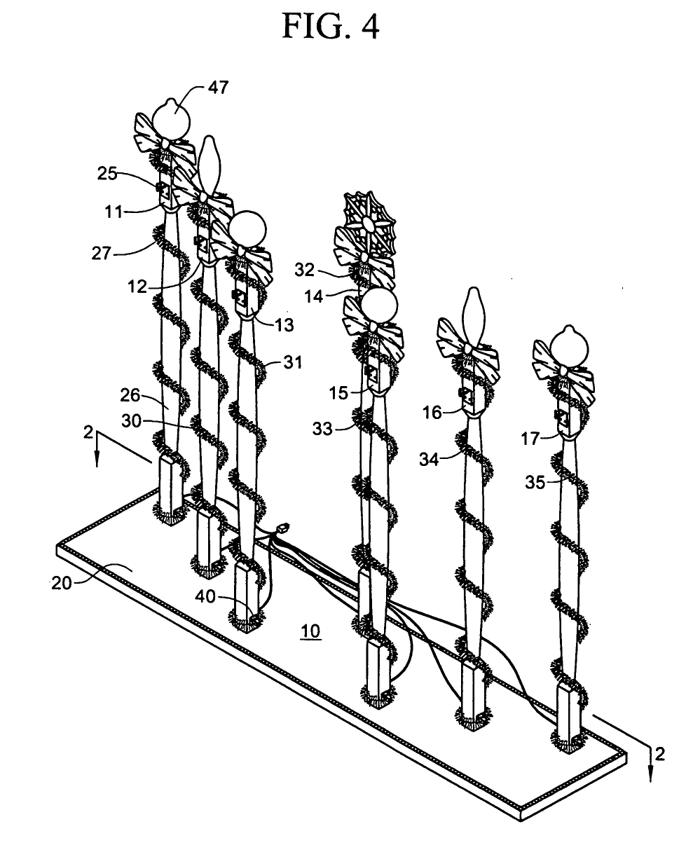

As illustrated in FIG. 4, each of the struts 12 through 17 is secured to the flat surface 20 of the base 10 in the manner previously described in connection with the strut 11.

Each of the struts 11 through 17, moreover, is festooned with a respective one of Charleston fir garlands 27, 30, 31 32, 33, 34, 35 or other decoration appropriate to the occasion. The Charleston fir garlands 27, and 30 through 35 shown in FIG. 4 are made of flame retardant materials that each have an entwined string of electric lights of which lights 36, 37 (FIG. 1) are typical. Garlands suitable for the purpose of the invention are identified as Model #M-P70718 and can be purchased from Wal-Mart.

The garlands 27 and 30 through 35 (FIG. 4) are fastened to their respective struts 11 through 17 by means of clips, of which a first clip 40 (FIG. 3) on the strut portion 24 is shown. The garland 27 also is secured to the portion 26 on the strut 11 by means of another associated clip 40′ that presses the other end of the garland 27 to the second portion 26 of the strut 11.

The remaining struts 12 through 17 are each similarly decorated with respective individual garlands 30 through 35.

Turning once more to FIG. 1, the base 10 also supports further decorations of which a Santa Claus image 42, artificial snow drifts 43, further lights 44, 45, a multi-colored cord 46 around the periphery of the base 10 and the like are illustrative. Each of the struts 11 through 17 is completed by means of Christmas ornament finials, of which finial 47 (FIGS. 1 and 3) is typical. With particular attention to FIG. 3, note that the finial 47 has a 2½ inch stem 50 that protrudes from an end of the finial 47. The stem 50 is received in the 2 inch hole 29 described above with respect to the first portion 24 of the strut 11. Preferably, the stem 50 is glued within the mating 2 inch hole 29 that is in alignment and coincident with the longitudinal axis 28 of the strut 11. Six other finials shown in FIG. 1 also are secured to their respective struts 12 through 17 in a manner similar to that described above in connection with the finial 47 and the strut 11.

In operation, each of the Christmas stockings in the array 18 (FIG. 1) is mounted on an individual one of the struts 11 through 17 (FIG. 4) by attaching the stockings each to an individual hanger (of which the hanger 25 shown in FIG. 3 is typical). As best shown in FIG. 1, the structure that characterizes the invention presents each of the stockings in an essentially linear array. As a result, names 51 on each of the stockings in the array 18 are immediately apparent to the proper gift recipients. In this manner the need for the recipients to search in and through the radial presentation of the prior art to find a particular stocking is overcome.

Upon removal of a stocking, tipping the entire structure should be unnecessary. But, if the structure is tipped, the stability to overcome the tipping force is achieved for at least two reasons. First, depending on the direction in which exemplary stocking 52 (FIG. 1) is tipped, the other six stockings will lay up against their respective struts 11 through 16 and will not sway through the full heeling angle applied to the stocking 52. In this manner the consequence of the heeling impact is attenuated as that impact is dissipated among the other six stockings. Second, because each of the struts 11-17 are angularly staggered relative to each other there are restoring moments applied by at least some of the other six stockings distributed across the surface 20 of the base 10 that counterbalance the tipping moment applied to only one of the stockings and its associated strut.

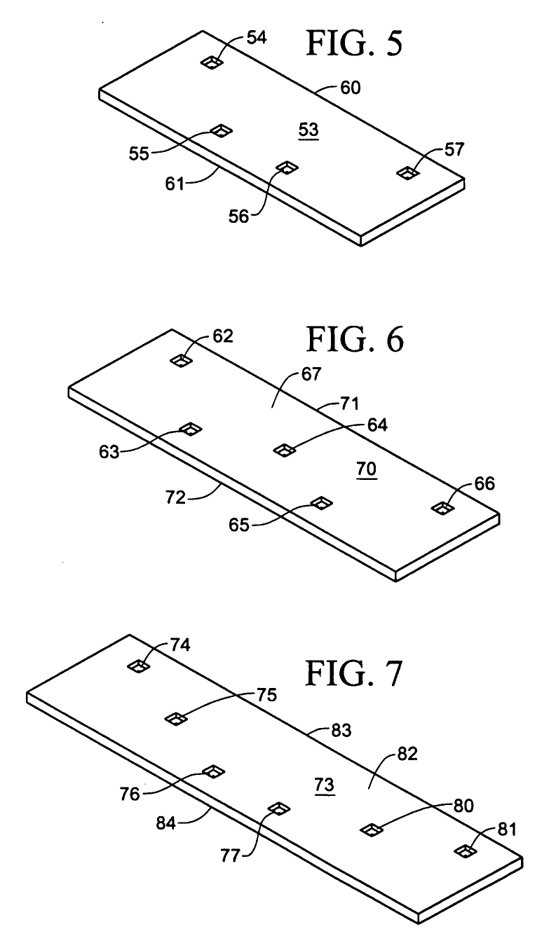

As mentioned above, a special advantage of the invention is its adaptability to different numbers of gift recipients. In this respect, attention is invited to FIG. 5 which illustrates an embodiment of the invention adapted to four gift recipients. A base 53 formed preferably from a wooden plank 29 inches long, 11½ inches wide and 1 inch thick supports four struts 54, 55, 56, 57. The four struts 54-57 in accordance with the invention enjoy the following angular relationship between consecutive pairs of the struts, measured relative to lengthwise side 60 of the base 53 as follows:

| Strut Pairs | Angle | |
|---|---|---|
| 54-55 | 38° | |
| 55-56 | 0° | |
| 56-57 | −38° | (measured from side 61) |

Separation between the struts in each of these pairs measured parallel to the lengthwise sides 60, 61, is about 6 inches. Further with respect to the invention note that it is not necessary for all of the struts in a given array to be staggered relative to each other as shown by the 0° angular separation between the strut pairs 55-56.

A structure suitable for five gifts or gift recipients is shown in FIG. 6 in which struts 62, 63, 64, 65 and 66 are each secured to flat surface 67 for base 70. The five struts 62 through 66 are mounted approximately 6 inches apart from each other, as measured parallel with sides 71 and 72 of the base 70, the base 70 being about 35¼ inches in length, 11½ inches in width and 1 inch thick. The angular relationships between adjacent strut pairs, measured relative to the sides 71 and 72 are shown in the following table:

| Strut Pairs | Angle | |
|---|---|---|
| 62-63 | 38° | |
| 63-64 | −28° | (measured from side 72) |
| 64-65 | 28° | |
| 65-66 | −38° | (measured from side 72) |

Attention now is invited to base 73 (FIG. 7), the base 73 being suitable to accommodate six gifts (not shown in FIG. 7) for recipients, these gifts, or stockings being each individually mounted on a respective one of struts 74, 75, 76, 77, 80 and 81 that protrude generally perpendicularly from surface 82 of the base 73. The base 73, for example, is 43½ inches in length, 11½ inches in width and 1 inch in thickness. Further in this regard adjacent pairs of the struts are spaced 6 inches apart when measured parallel to sides 83, 84 of the base 73. Exemplary angular separations of adjacent strut pairs, measured relative to the sides 83, 84 of the base 73 are:

| Strut Pairs | Angle | |
|---|---|---|
| 74-75 | 15° | |
| 75-76 | 15° | |
| 76-77 | 0° | |
| 77-80 | −15° | (measured from side 84) |
| 80-81 | −15° | (measured from side 84) |

Once more attention is invited to the fact that not all of the strut pairs in a given array necessarily need to be angularly staggered relative to each other as indicated by the 0° angular relation between the struts 76 and 77 as shown in FIG. 7.

Clearly, the structures disclosed in the foregoing detailed description represent a marked improvement over the prior art in that the dispositions of adjacent pairs of the supporting struts relative to sides of the bases on which they are mounted make an accidental heeling over onto a floor, table or the like almost impossible. The essentially linear display of the stockings or gifts borne on the individual struts makes recipient access easier and safer, again from the structural stabilizing standpoint. The principles of the invention as described herein also are adaptable to any number of strut/base combinations.

What is claimed is:

1. A decorative apparatus for distributing gifts to recipients comprising a base having a pair of lengthwise sides, a plurality of struts separated from each other and mounted on said base generally perpendicular thereto, adjoining pairs of said struts being angularly disposed from each other relative to said lengthwise base sides, and means on each of said struts for supporting at least one of the gifts thereon.

2. An apparatus according to claim 1 further comprising Christmas stockings bearing the gifts, said Christmas stockings being disposed on said respective struts by said support means.

3. An apparatus according to claim 1 wherein in said plurality of struts at least some of adjoining pairs of said struts are angularly spaced from each other within a range of ±15° to ±46° relative to said lengthwise sides.

4. An apparatus according to claim 1 further comprising a plurality of garlands, at least some said garlands being mounted on a respective one of said struts in said plurality thereof, and means on said struts for mounting said garlands thereon.

5. An apparatus according to claim 4 wherein said garland mounting means further comprise resilient clips.

6. An apparatus according to claim 1 further comprising a plurality of finials, each of said finials being mounted on at least some of said struts in said plurality thereof.

7. An apparatus according to claim 4 further comprising electric lights entwined in said plurality of garlands.

8. An apparatus according to claim 7 further comprising decorations mounted on said base.
